(19) United States
(12) Patent Application Publication
(10) Pub. No.: US 2025/0232069 A1
(43) Pub. Date: Jul. 17, 2025

(54) CUSTOMIZED MOUTHPIECE CASE INSERT

(71) Applicant: James R. Glidewell Dental Ceramics, Inc., Newport Beach, CA (US)

(72) Inventors: Santosh Gaikwad, Irvine, CA (US); David C. Leeson, Laguna Beach, CA (US); Priyank Patel, Anaheim, CA (US); Dean Dohi, Anaheim, CA (US); Thomas Quinn, Ware (GB); Fernando Vera, Fountain Valley, CA (US)

(73) Assignee: James R. Glidewell Dental Ceramics, Inc., Newport Beach, CA (US)

(21) Appl. No.: 19/018,237

(22) Filed: Jan. 13, 2025

Related U.S. Application Data
(60) Provisional application No. 63/668,673, filed on Jul. 8, 2024.
(60) Provisional application No. 63/621,569, filed on Jan. 16, 2024.

(51) Int. Cl. G06F 30/10; G06F 30/39; G06F 113/10; G06F 113/20; G06F 115/12; G06T 17/00

(52) U.S. Cl. CPC G06F 30/10; G06F 30/39; G06T 17/00; G06F 2113/10; G06F 2113/20; G06F 2115/12

(57) ABSTRACT

A method for making a case insert for a mouthpiece having an embedded circuit board is disclosed. The method includes receiving a digital representation of a teeth model, creating a first shell model based at least in part on the digital representation of the teeth model, placing one or more objects modeling the embedded circuit board on the first shell model, creating a second shell model covering the first shell model and the one or more objects, and creating a case insert model based at least in part on the second shell model.

### CROSS-REFERENCE TO RELATED APPLICATIONS

This application claims the benefit of and priority to U.S. Provisional Patent Application No. 63/668,673 filed Jul. 8, 2024, and U.S. Provisional Patent Application No. 63/621,569 filed Jan. 16, 2024, both of which are incorporated herein by their entirety.

### FIELD

The present disclosure concerns case inserts for mouthpieces, as well as systems and methods for making the same.

### BACKGROUND

Fitness tracking devices, or fitness trackers, have been used to monitor fitness-related metrics and provide feedback on an individual's performance. Exemplary metrics monitored by the fitness trackers include heart rate, respiration rate, oxygen saturation level, etc. Many existing fitness trackers are cumbersome and/or sensitive to motion of the users. For example, some fitness trackers include heart rate monitors which place electrodes or a strap around the user's chest. A less intrusive technique, pulse oximetry, uses a photoplethysmograph (PPG) sensor to non-invasively measure light absorption through a user's tissue to determine heart rate and oxygen saturation level. However, this requires the user to remain relatively motionless to obtain a good signal. Thus, there is a room for improvement in wearable technology for fitness tracking.

### SUMMARY

Described herein are systems and methods for making customized casing or enclosure for a fitness tracker, or more specifically, a case insert for a mouthpiece having an embedded circuit board configured to measure physiological metrics of a user of the mouthpiece.

Certain examples of the disclosure concern a method for making a case insert for a mouthpiece having an embedded circuit board. The method includes receiving a digital representation of a teeth model, creating a first shell model based at least in part on the digital representation of the teeth model, placing one or more objects modeling the embedded circuit board on the first shell model, creating a second shell model covering the first shell model and the one or more objects, and creating a case insert model based at least in part on the second shell model.

Certain examples of the disclosure also concern a system for making a case insert for a mouthpiece having an embedded circuit board. The system includes memory, one or more hardware processors coupled to the memory, and one or more computer readable storage media storing instructions that, when loaded into the memory, cause the one or more hardware processors to perform operations. The operations include receiving a digital representation of a teeth model, creating a first shell model based at least in part on the digital representation of the teeth model, placing one or more objects modeling the embedded circuit board on the first shell model, creating a second shell model covering the first shell model and the one or more objects, and creating a case insert model based at least in part on the second shell model.

Certain examples of the disclosure further concern one or more non-transitory computer-readable media having encoded thereon computer-executable instructions causing one or more processors to perform a method for making a case insert for a mouthpiece having an embedded circuit board. The method includes receiving a digital representation of a teeth model, creating a first shell model based at least in part on the digital representation of the teeth model, placing one or more objects modeling the embedded circuit board on the first shell model, creating a second shell model covering the first shell model and the one or more objects, and creating a case insert model based at least in part on the second shell model.

The technology described herein can be used in a number of applications. For example, the technology described herein can be used to produce a three-dimensional (3D) artifact of the case insert model. The 3D artifact can be a mouthguard, a gum shield, an orthodontic appliance (e.g., used to alleviate or treat snoring or sleep apnea), a retainer, among others.

The foregoing and other features and advantages of the disclosed technologies will become more apparent from the following detailed description, which proceeds with reference to the accompanying figures.

### BRIEF DESCRIPTION OF THE DRAWINGS

FIG. 1A is a schematic cross-sectional view of a mouthpiece.

FIG. 1B schematically depicts a circuit board embedded within the mouthpiece of FIG. 1A.

FIG. 2 is an overall block diagram of a case insert fabrication system.

FIG. 3 is a flowchart illustrating an example overall method of making a case insert for a mouthpiece with an embedded circuit board.

FIG. 4A is an example digital representation of a teeth model.

FIG. 4B depicts a modified teeth model in which gaps between adjacent teeth are filled.

FIG. 5A is a side view of a first shell model created without removing undercuts of a teeth model.

FIG. 5B is a cross-sectional view of the first shell model of FIG. 5A, taken along line 5B-5B, showing an undercut of the teeth model.

FIG. 5C is a side view of another first shell model in which undercuts of the teeth model are removed.

FIG. 6A is a front elevation view of a first shell model with an identified midline, according to one example.

FIG. 6B is a perspective view of the modified first shell model of FIG. 6A with added objects representing different parts of a circuit board.

FIG. 7A depicts a second shell model, according to one example.

FIG. 7B schematically depicts a space between a first shell model and a second shell model.

FIG. 8A depicts a second shell model including a palatal surface, according to one example.

FIG. 8B depicts a wedge block inserted into a concave side of the second shell model of FIG. 8A.

FIG. 8C depicts the second shell model of FIG. 8A in which the palatal surface is removed.

FIG. 8D depicts a second shell model including a filled palatal surface, according to one example.

FIG. 8E depicts the second shell model of FIG. 8D, in which a spacer is inserted.

FIG. 8F depicts a wall deformer applied to the second shell model of FIG. 8D.

FIG. 8G depicts the second shell model of FIG. 8E, in which a bump or deformation is formed in a wall.

FIG. 8H depicts the second shell model of FIG. 8G, in which an electronic component space is inserted.

FIG. 9A depicts adding a spacer to the modified second shell model of FIG. 8C.

FIG. 9B depicts surfaces connecting the spacer to the modified second shell model being smoothed.

FIG. 9C depicts adding a flat surface to the external surface of the modified second shell model of FIG. 8E.

FIG. 10A is a side view of a fabricated case insert.

FIG. 10B is a bottom view of the case insert of FIG. 10A.

FIG. 10C is a top view of the case insert of FIG. 10A.

FIG. 10D is a top view of another example of a fabricated case insert.

FIG. 10E is a bottom view of the case insert of FIG. 10D.

FIG. 11 is a block diagram of an example computing system in which described technologies can be implemented.

### DETAILED DESCRIPTION

### Overview of Smart Mouthpiece Technologies

To overcome problems of many existing fitness trackers, smart mouthpieces have been developed. Specifically, each mouthpiece is customized to fit a user's teeth so that the mouthpiece can be worn, in use, within a user's mouth. The mouthpiece can be embedded with a printed circuit board (“PCB”, or simply “circuit board”) with one or more sensors configured to measure the user's physiological signals. The mouthpiece with integrated sensing capabilities can outperform many existing fitness trackers worn on other body parts. For example, its personalized fit ensures stability and minimal interference from body movements, leading to more accurate, noise-free data. This allows for precise, real-time monitoring of physiological signals, even during intense activity, without the discomfort or inconvenience associated with chest straps or wristbands.

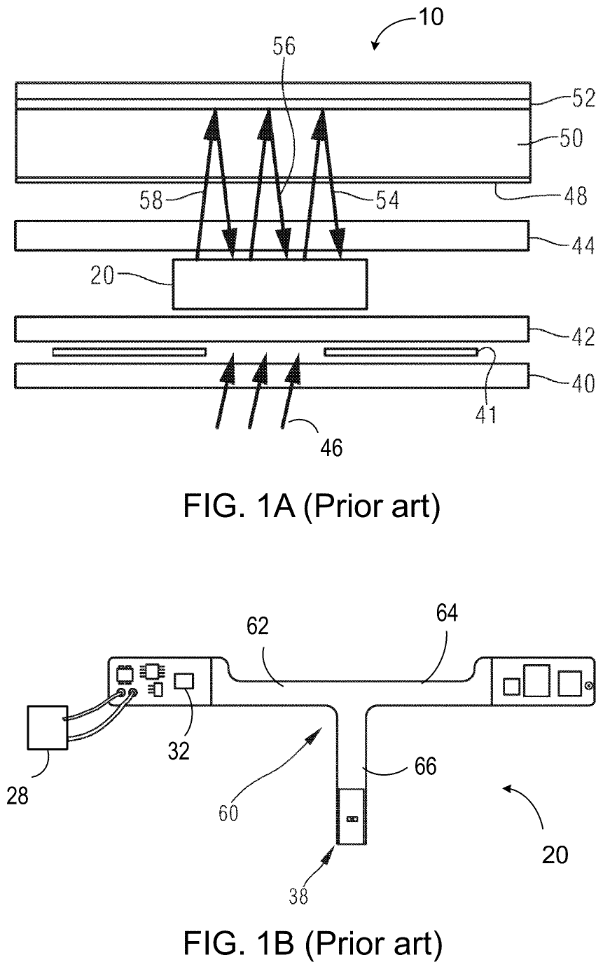

FIG. 1A depicts an example mouthpiece 10 having an embedded circuit board 20, and FIG. 1B depicts parts of the circuit board 20.

As shown in FIG. 1A, the mouthpiece 10 can include multiple thin layers of material. An outer layer 40 (also referred to as “protective layer”) can be substantially transparent to allow light to pass therethrough. An inner layer 44 that is closest to the user's teeth and gum can be substantially transparent to allow light to pass therethrough. A mid-layer 42, which is positioned between the inner layer 44 and the outer layer 40, can be black or have a very dark color that substantially prevents light from passing therethrough. Each of the outer layer 40, mid-layer 42, and inner layer 44 can be formed of Ethylene-Vinyl Acetate (EVA) plastic through a thermoforming process. In some examples, labels 41 carrying information and/or logos may be sandwiched between the outer layer 40 and the mid-layer layer 42.

The circuit board 20, which includes a light source 32 (e.g., an LED) and a PPG sensor 38 (which will conventionally also have a light source such as an LED), can be substantially sandwiched between the mid-layer 42 and the inner layer 44. Thus, any ambient light 46 entering the user's mouth can be blocked by the mid-layer 42 and thus prevented from interfering with the PPG sensor 38. Light emitted from the light source 32 or the light source associated with the PPG sensor 38 (e.g., with wavelength between 10 nm and 3000 nm) can shine through the inner layer 44, onto the user's skin 48, and through an underlying mouth tissue 50 to blood vessel(s) 52. The reflected light can return to the PPG sensor 38, where the amplitudes of reflected green 54, red 56 and infrared 58 light can be measured, based on which the user's PPG signal can be obtained. Physiological metrics such as heart rate, oxygen concentration, respiration rate, etc., can be obtained from the PPG signal. In some examples, the PPG sensor 38 can be placed adjacent to the user's palate, which can reflect the light emitted by the light source 32 or the light source associated with the PPG sensor 38 to the PPG sensor 38.

As shown in FIG. 1B, the circuit board 20 can be configured to have multiple separate sections, connected together by a flexible connector in the form of, for example, polyimide flexible PCB material. In the depicted example, the circuit board 20 has a left arm 62, a right arm 64, and a central leg 66 that are interconnected with each other to define a substantially T-shaped flexible connector 60. Some electronic components of the circuit board 20 (e.g., the light source 32, external flash memory, etc.) can be disposed at an end portion of the left arm 62. A power supply unit 28 (e.g., a Lithium polymer battery) can also be connected to the left arm 62 via conducting wires or cables. Some electronic components of the circuit board 20 (e.g., a microcontroller, an inertial measuring unit, a high impact accelerometer, etc.) can be disposed at an end portion of the right arm 64. In the depicted example, the PPG sensor 38 can be disposed at an end portion of the central leg 66. It should be understood that the shape and/or size of the circuit board 20 can vary, and the exact locations of different electronic components of the circuit board 20 can also differ from the example depicted in FIG. 1B. For example, some electronic components disposed on the left arm 62 can be switched to the right arm 64, or vice versa.

Further details of the mouthpieces with embedded circuit boards are described in U.K. Patent Application GB 2595723, which is incorporated by reference herein.

In some circumstances, it is desirable to pair the mouthpiece described above with a case insert. When not in use, the mouthpiece can be placed within the case insert for storage. Optionally, the case insert can include a wireless charging system configured to wirelessly charge the power supply unit or battery of the mouthpiece. For example, the case insert can include one or more transmitting coils that are positioned to align with a receiving coil located on the circuit board of the mouthpiece so as to enable wireless charging through magnetic coupling between the transmitting and receiving coils.

However, creating a case insert for a customized mouthpiece presents technical challenges. Each mouthpiece is unique to a specific user (e.g., the mouthpiece can be created based on a teeth model of the specific user), thus requiring individualized case designs. Creating the case insert subsequent to the mouthpiece would prolong the overall manufacturing process, resulting in extended waiting periods for the end user. Additionally, when the case insert is engineered to charge the mouthpiece's power supply unit or battery, slight mismatch between the mouthpiece and the case insert can lead to misalignment between the transmitting and receiving coils, thereby negatively impacting the charging efficiency.

Many of the above challenges can be overcome by the case insert fabrication technologies described herein.

### Example System for Fabricating Case Inserts

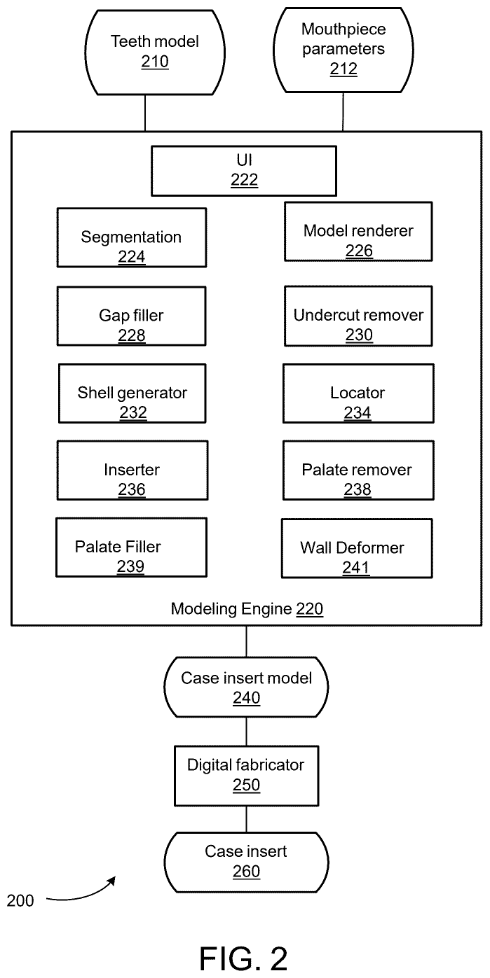

FIG. 2 shows an overall block diagram of an example fabrication system 200 that can be used for computer-aided design (CAD) and computer-aided manufacturing (CAM) of case inserts for smart mouthpieces, such as the mouthpiece 10 described above.

The fabrication system 200 includes a modeling engine 220 configured to create a case insert model 240 for a mouthpiece, based on a digital representation of a teeth model 210 (or simply “teeth model”) and specific parameters 212 of the mouthpiece. The case insert model 240, typically represented as CAD files, can be supplied to a digital fabricator 250 to produce a case insert 260 for the mouthpiece. The digital fabricator 250 could be a 3D printer, a computer numerical control (CNC) machine, a laser cutter, or any other computer-controlled manufacturing devices set up to execute a CAM process. The entire process, from receiving the teeth model 210 and mouthpiece parameters 212, to generating the case insert model 240 and fabricating the case insert 260, can be automated or substantially automated, thanks to the capabilities of the modeling engine 220 and the digital fabricator 250.

As shown in FIG. 2, the modeling engine 220 can include a plurality of components, including a user interface 222 (UI), a segmentation unit 224, a model renderer 226, a gap filler 228, an undercut remover 230, a shell generator 232, a locator 234, an inserter 236, and a palate remover 238. In some embodiments, the modeling engine 220 can also include a palate filler 239, and a wall deformer 241. Each of these components is configured to implement one or more functions described further below. In other examples, some of these components can be combined and/or one or more of these components may be split into multiple sub-components.

The modeling engine 220 can receive the teeth model 210 and mouthpiece parameters 212 through the user interface 222. The teeth model 210 can be represented by 3D model files in a variety of data format, such as STL (Standard Tessellation Language), PLY (Polygon File Format), OBJ (Object File Format), DICOM (Digital Imaging and Communications in Medicine), STEP (Standard for the Exchange of Product Data), etc. The mouthpiece parameters 212 define various geometric parameters of the mouthpiece, which can be fabricated based on the same or substantially the same teeth model 210. For example, for the mouthpiece 10 described above, the mouthpiece parameters 212 include, but are not limited to, thicknesses of the inner layer 44, mid-layer 42, and outer layer 40 of the mouthpiece, positions and sizes of the circuit board 20 (including the left arm 62, the right arm 64, the central leg 66, etc.) relative to the inner layer 44, positions and sizes of various components (e.g., the power supply unit 28, the PPG sensor 38, etc.) located on or being connected to the circuit board 20, etc.

Through the user interface 222, a user can view and interact with any models rendered by the model renderer, e.g., changing viewing angles, zooming in/out, viewing cross-sections, etc. Additionally, through the user interface 222, the user can also change or edit parameters of the modeling engine 220 that control various aspects of the CAD process (e.g., modeling rendering, segmentation, shell generation, palate removal, etc.), as described further below.

The model renderer 226 can be configured for displaying the received teeth model 210 and any generated model (e.g., shell models generated by the shell generator 232 and the final case insert model 240) on the user interface 222. For a given model, the model renderer 226 can render it into a visual format that can be easily interpreted by a user, who can view and/or manipulate the rendered model through the user interface 222.

The segmentation unit 224 can be configured for pre-processing of the teeth model 210, e.g., by employing segmentation techniques like thresholding, region growing, or watershed to divide the teeth model 210 into distinct objects. These objects can include individual teeth, gum, palate, and more. The segmentation unit 224 can also identify different surfaces of the teeth such as occlusal surface, front surface, lingual surface, etc. As described herein, the occlusal surface refers to the surface of a tooth that comes in contact with the corresponding tooth in the opposite jaw during occlusion or biting, the front surface (also referred to as “facial surface”) refers to the surface of a tooth that faces lip or cheek, and lingual surface refers to the surface of a tooth that faces the tongue. In some examples, the segmentation unit 224 can be configured to implement teeth segmentation using neural networks, as described in U.S. Pat. No. 11,842,484, which is incorporated by reference herein. Other segmentation techniques can also be used by the segmentation unit 224.

The gap filler 228 is configured to identify gaps between adjacent teeth in the teeth model 210 and fill those gaps using virtual fillers. These virtual fillers can be generated based on the surrounding teeth so that the filled gaps blend seamlessly with the rest of the teeth model, resulting in a continuous teeth structure.

The undercut remover 230 is configured to identify undercuts in the teeth model 210 and fill the undercuts with virtual fillers. An undercut is a recessed area in the teeth model that is inaccessible from a single direction, e.g., the occlusion direction which can be about perpendicular to the occlusal (or top) surface of the teeth. By filling these undercuts with virtual fillers, the undercut remover 230 can remove the undercuts so that the front or facial side of the teeth forms a smooth and substantially flat surface. As explained further below, by removing the undercuts, the fabricated case insert 260 can have a substantially straight inner surface which allows the mouthpiece to be easily and smoothly inserted thereinto.

The shell generator 232 is configured to generate at least two different shells or shell models in sequential steps. Specifically, the shell generator 232 can create a first shell model (or “first shell”) based on the teeth model 210 that is devoid of gaps between teeth (e.g., by applying the gap filler 228 to the teeth model) and undercuts (e.g., by applying the undercut remover 230 to the teeth model). The first shell model represents a modified inner layer (e.g., the inner layer 44) of the mouthpiece. For example, the size and overall shape of the first shell model can mimic those of the inner layer, except for the undercuts being removed. The thickness of the inner layer (e.g., specified in the mouthpiece parameters 212) can define a thickness of the first shell model. After objects representing an embedded circuit board is placed over the first shell model (as described further below), the shell generator 232 can create a second shell model (or “second shell”) covering the first shell model and those objects. The second shell model can be a digital representation of the mouthpiece without undercuts. The shell generator 232 can create the first and/or second shell models using surface offset techniques such as point-based offsetting method of polygonal meshes (where each point on the surface of a polygonal mesh is moved or offset to create a new surface), voxel-based surface offsetting (where the surface of an object, represented as a 3D grid of voxels, is expanded or contracted to create a new surface.), or the like.

The locator 234 is configured to identify specific locations on the teeth model and/or shell models with precision. The inserter 236 is configured to insert or add different objects to the created shell models. For example, the locator 234 can locate a midline of the first shell model, based on which can further locate areas on the first shell model where objects representing different parts of the circuit board can be placed, e.g., by the inserter 236. Locations, sizes, and shapes of those areas can be obtained from mouthpiece parameters 212. The locator 234 can also locate areas on the second shell model where other parts of the case insert model 240 (e.g., a spacer, a base plate, etc.) can be added, e.g., by the inserter 236, to produce the case insert model 240.

The palate remover 238 is configured to identify a palatal surface in the teeth model 210 and prevent the palatal surface from appearing in the case insert model 240. In some examples, the received teeth model 210 may include residuals of a palatal surface, e.g., due to imaging artifacts, which are generally unnecessary or undesirable to be included in the fabricated case insert 260. Such residuals of palatal surface, if exist, can be subtracted from the second shell model by the palate remover 238, e.g., by inserting a wedge block into a concave side of the second shell model, as described further below.

The palate filler 239 is configured to identify a volume of a recess between two wings of a shell model and to virtually fill the recess in order to block out the volume for subsequent operations. The wall deformer 241 is configured to add a bump or deformation in a wall of the case insert model 240 that is opposite of the location of a charging coil that is installed on the fabricated case insert 260. In some examples, an improvement in charging performance can be achieved by forming a bump or deformation on a wall of the case insert that creates a force on the mouthguard biasing the opposing side of the mouthguard into a close engagement with the opposing wall of the case insert 260, where the charging component is located. The biasing bumper 239 has a size and shape adapted to optimize the size and location of the bump or deformation to achieve this effect, as described further below.

The described fabrication system 200 can be networked via wired or wireless network connections, including the Internet. Alternatively, the fabrication system 200 can be connected through an intranet connection (e.g., in a corporate environment, government environment, or the like).

The fabrication system 200 and any of the other systems described herein can be implemented in conjunction with any of the hardware components described herein, such as the computing systems described below (e.g., processing units, memory, and the like). In any of the examples herein, the teeth model, mouthpiece parameters, shell models, case insert model, and the like can be stored in one or more computer-readable storage media or computer-readable storage devices. The technologies described herein can be generic to the specifics of operating systems or hardware and can be applied in any variety of environments to take advantage of the described features.

### Example Methods for Creating Case Insert Model and Fabricating Case Insert

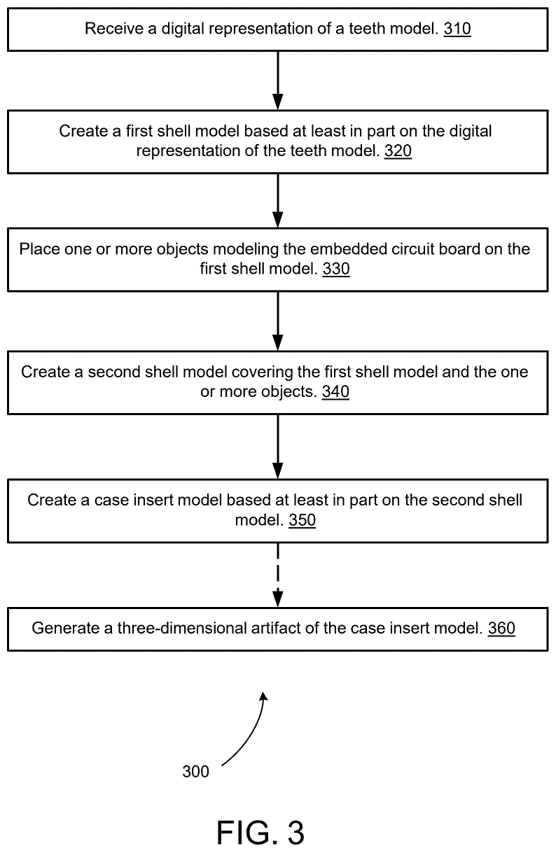

FIG. 3 is a flowchart describing an overall method 300 for producing a case insert model for a mouthpiece having an embedded circuit board, and optionally for fabricating a physical case insert using the case insert model. The method 300 can be performed, for example, by using the fabrication system 200 of FIG. 2.

At step 310, a digital representation of a teeth model is received. Additionally, parameters of the mouthpieces can also be received as input. In some examples, the mouthpiece itself can be fabricated based on the same or substantially the same teeth model. The teeth model can be generated by any known imaging modalities. For example, the teeth model can be generated by scanning a user's mouth using an intraoral scanner, or by scanning a traditional impression or model with a desktop optical scanner. The scanned images can then be processed to create a 3D representation of the teeth model. Additionally, X-ray computed tomography (CT) scans can also be used to generate a 3D image of the teeth, which can then be converted into the teeth model.

At step 320, a first shell model can be created, e.g., by the shell generator 232, based at least in part on the received teeth model. The first shell model is configured to contact and cover the front or facial side of the teeth model, just like the inner layer of the mouthpiece contacts the front surface of the teeth.

In some examples, pre-processing of the teeth model can be performed prior to creation of the first shell model. For example, one or more gaps between adjacent teeth in the teeth model can be identified and filled with virtual fillers, e.g., by the gap filler 228. Filling gaps between adjacent teeth in the teeth model before generating the first shell model can ensure a smooth and continuous surface for the shell model.

Additionally, one or more tooth undercuts in the teeth model can be identified and removed (e.g., via virtual fillers), e.g., by the undercut remover 230. The inner layer of the mouthpiece is generally designed to match the front surface of the teeth model, which may include undercuts. Undercuts are indentations or recesses on the front surface of the teeth that would be inaccessible, e.g., in the occlusion direction. When creating the first shell model for the case insert, these undercuts are intentionally removed to ensure that an inner surface of the case insert is more straightforward and less complex in shape. If the undercuts were not removed during the creation of the first shell model, they would create a contoured shape that could obstruct the insertion of the mouthpiece into the case insert, e.g., in the occlusion direction. Thus, removing the undercuts in the teeth model before creating the first shell model can ensure a smooth, unobstructed path for the mouthpiece to be inserted into the case insert, e.g., in the occlusion direction.

Generally, the size, contour, and thickness of the first shell model can match those of the inner layer of the mouthpiece, except for the absence of undercuts in the first shell model. In other words, the created first shell model can be a digital representation of the mouthpiece's inner layer devoid of undercuts. In certain examples, the first shell model can be taller (measured in the occlusion direction) than the inner layer of the mouthpiece.

At step 330, one or more objects modeling an embedded circuit board (e.g., the circuit board 20) can be placed on the first shell model, e.g., by the inserter 236. The precise locations of the objects placed on the first shell model can be automatically determined, e.g., by the locator 234. Positioning of the objects can mirror the placements of different parts of the circuit board and related components (e.g., the left arm 62, the right arm 64, the central leg 66, the power supply unit 28, the PPG sensor 38, etc.).

At step 340, a second shell model covering the first shell model and the one or more objects modeling the circuit board can be created, e.g., by the shell generator 232. The second shell model can act as a representation of the mouthpiece, specifically designed without any undercuts. In certain examples, the second shell model can be taller (measured in the occasion direction) than the actual mouthpiece. In some examples, the created second shell model can be further processed to remove any residual artifacts that otherwise would appear as portions of a palatal surface. For example, residuals of a palatal surface may exist in the received teeth model and be carried over in the created first and second shell models. Such residual palatal surface can be subtracted from the second shell model, e.g., by the palate remover 238. In some examples, the created second shell model can be further processed by filling the recess volume, e.g., with the palate filler 239, and providing a bump or deformation on an outer wall of the second shell model, e.g., by the wall deformer 241. The bump or deformation will be reflected in the case insert model (explained below) and will provide a biasing force that maintains improved contact between the mouthpiece and a charging component.

Then, at step 350, a case insert model can be created based at least in part on the second shell model (e.g., after removal of artifacts representing the palatal surface and/or after making other modifications to the second shell model described herein). For example, a spacer and a base plate can be added to the second shell model, as described further below.

Optionally, at step 360, a 3D artifact of the case insert model can be fabricated. The 3D artifact represents the physical case insert that is specifically designed to receive the mouthpiece. Fabrication of the 3D artifact can be achieved by 3D printing, CNC machining, laser cutting, or any other computer-controlled manufacturing techniques. Because the case insert model can be created based on the same teeth model that is used to create the mouthpiece, an inner surface of fabricated case insert can generally match the contour of the mouthpiece except for the removal of areas representing teeth undercuts. As a result, the mouthpiece can be easily inserted into the case insert, e.g., along an occlusion axis (which can be about perpendicular to the occlusal surface of the mouthpiece). Small gaps corresponding to the removed undercuts can exist between the case insert and the mouthpiece inserted therein. Nonetheless, the mouthpiece can snug fit within the case insert, while lateral movement (e.g., in directions perpendicular to the occlusion axis) of the mouthpiece within the case insert is prohibited.

The method 300 described in the flowchart of FIG. 3 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “send” can also be described as “receive” from a different perspective.

### Example Fabrication Process

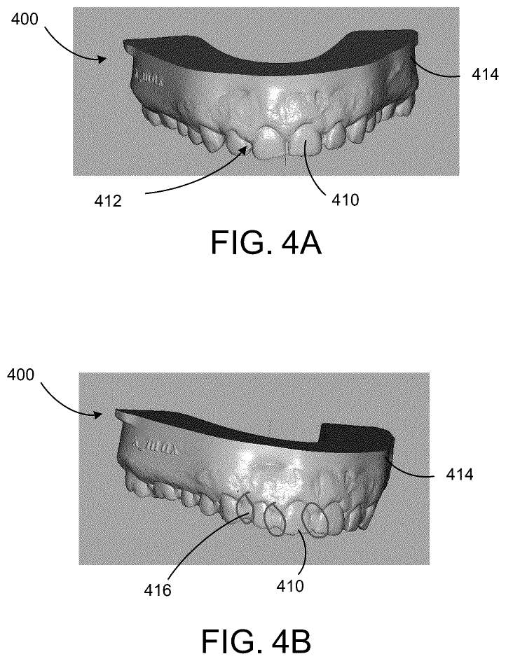

The fabrication method 300 described above can be further illustrated in FIGS. 4A-9C, which depicts various stages of a fabrication process for making a customized case insert for a specific mouthpiece.

FIG. 4A shows a computer-rendered teeth model 400 (e.g., generated by the model renderer 226). The specific mouthpiece can be fabricated based on the same or substantially the same teeth model 400. Preprocessing can be performed to identify individual teeth 410, gum 414, and gaps 412 between adjacent teeth 410 (e.g., by the segmentation unit 224).

FIG. 4B shows the teeth model 400 (slightly tilted compared to FIG. 4A) in which the identified gaps between adjacent teeth 410 are filled with virtual fillers 416 (e.g., by the gap filler 228), as marked by the circles.

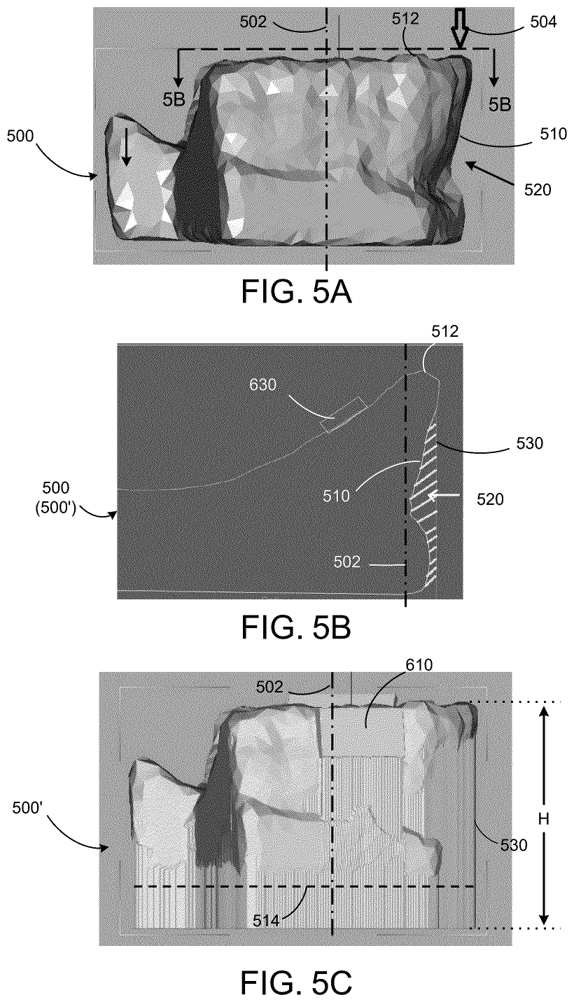

FIG. 5A shows a first shell model 500 created (e.g., by the shell generator 232) without removing undercuts of the teeth model 400. FIG. 5B shows a cross-sectional view of the first shell model 500 taken along line 5B-5B, which can represent a midline of the first shell model. As shown in FIGS. 5A-5B, a front surface 510 of the first shell model 500 can curve radially inwardly (e.g., a top portion of the teeth can extend further toward the cheek or lip relative to a bottom portion of the teeth) so as to define an undercut 520, which represents an area that is recessed relative to the height of the front contour of the teeth. FIGS. 5A-5B also show an occlusion axis 502, which can be perpendicular or substantially perpendicular to an occlusal surface 512 of the teeth model 400. For example, the occlusion axis 502 can extend between maxillary (upper) and mandibular (lower) teeth.

To make the case insert, the undercut 520 is undesirable and should be removed (e.g., by the undercut remover 230). Otherwise, when later a second shell model is created to cover the first shell model 500 (including the undercut 520), the curvature of an inner surface of the second shell model (and the resulting case insert) would approximately match the curvature of the front surface 510 of the first shell model 500. As a result, the inner surface of the case insert would have a portion that protrudes radially inwardly (toward the tongue) to occupy the recessed area represented by the undercut 520. Thus, when inserting the mouthpiece into the case insert, e.g., by moving the mouthpiece in an occlusion direction (as indicated by the arrow 504) relative to the mouthpiece, the mouthpiece could be blocked by the protruded portion of the inner surface of the case insert (e.g., a portion of the mouthpiece could be wider than the case insert at the protruded portion). As such, the mouthpiece would not be able to be completely received within the case insert.

FIG. 5C shows a first shell model 500′ in which undercuts of the teeth model are removed. Removal of the undercuts 520 can be achieved by adding a virtual filler to fill the undercut 520 (as indicated by the hashed area in FIG. 5B). As a result, the first shell model 500′ can have a substantially straight front surface 530 (as opposed to the curved front surface 510) through the height of the teeth and along the occlusion axis 502.

In some examples, the height (H) of the first shell model 500′ (measured along the occlusion axis 502) can be slightly larger than a corresponding height of the mouthpiece. Thus, when the mouthpiece is inserted into the resulting case insert (created based on the first shell model 500′), the bottom of the mouthpiece (indicated by the dashed line 514) can be slightly offset from the bottom of the case insert.

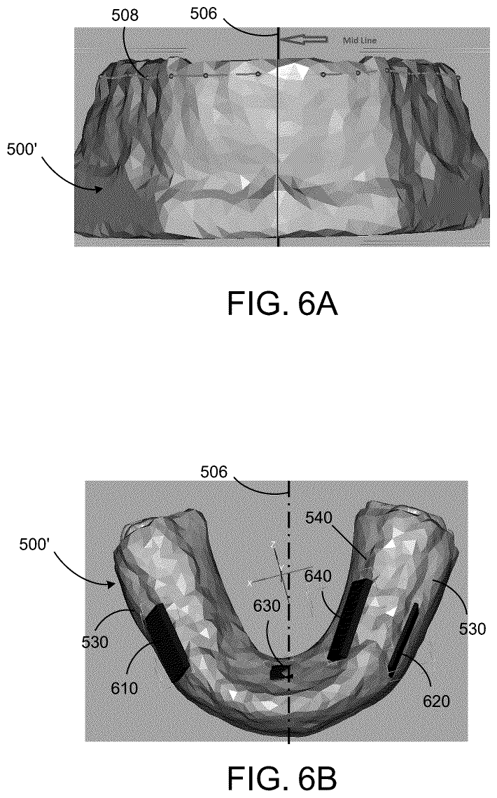

The circuit board (e.g., the circuit board 20) embedded in the mouthpiece can have several spatially distributed parts (connected by a flexible substrate), such as a left arm, a right arm, a central leg, and a power supply unit connected to one of the parts, as depicted in FIG. 1B. When generating the case insert model, each part can be modeled by a corresponding object. For example, FIG. 6B shows multiple objects representing different parts or components of a circuit board that are placed on the first shell model 500′ (e.g., by the inserter 236). As shown, a first object 610 can model a module or components included on the left arm, a second object 620 can model a module or components included on the right arm, a third object 630 can model a module or components (e.g., the PPG sensor) included on the central leg, a fourth object 640 can model the power supply unit, etc. Some of the objects (e.g., 610, 630) are also shown in FIGS. 5B-5C.

Positions and orientations of the objects (e.g., 610, 620, 630, 640, etc.) on the first shell model 500′ can be automatically determined (e.g., by the locator 234) based on parameters of the mouthpiece model, which can specify size and shape of the different parts of the circuit board, as well as positions of those parts relative to the inner layer of the mouthpiece. For example, as shown in FIG. 6A, a midline 506 of the first shell model 500′ which bisects the first shell model 500′ (e.g., into a left half and a right half) can be identified. An upper edge of the circuit board (e.g., top edges of the left and right arms) can be aligned with a circumferential line 508 having a predefined vertical distance to the top surface of the first shell model 500′. In some examples, the circumferential line 508 can represent the top or occlusal surface 512 of the teeth model 400. Different objects can be placed in reference to the midline 506 and/or the circumferential line 508. For example, both the first object 610 and second object 620 can be placed on the front surface 530 (also referred to as “facial surface”) of the first shell model 500′ but positioned on opposite sides of the midline 506. Circumferential distances between the first and second objects 610, 620 and the midline 506 can be specified by parameters of the mouthpiece. The third object 630 can be placed on a lingual surface 540 of the first shell model 500′ (e.g., opposite to the second object 620). The fourth object 640 can be aligned with the midline 506 and placed on or adjacent to the lingual surface 540 (e.g., to match the position of the PPG sensor located on the central leg).

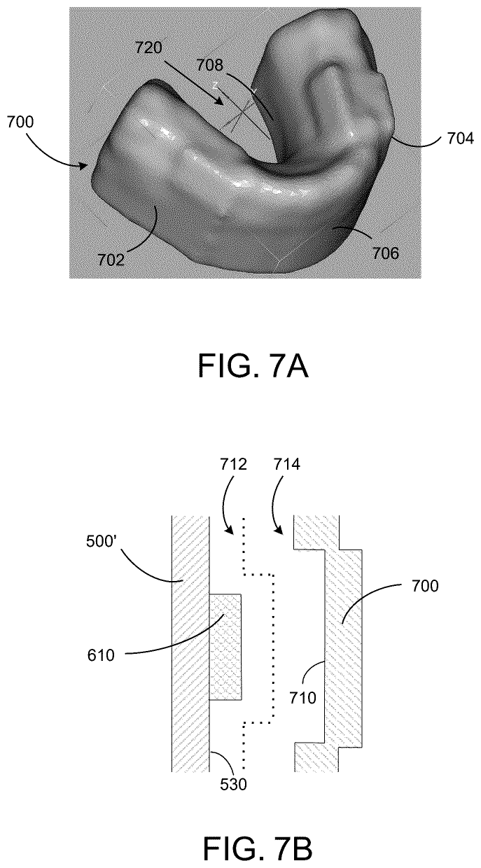

FIG. 7A shows a second shell model 700 created (e.g., by the shell generator 232) based on the first shell model 500′. The second shell model 700 is configured to substantially cover the first shell model 500′ and the objects (e.g., 610, 620, 630, 640, etc.) placed on the first shell model 500′. Thus, the height of the second shell model 700 will be slightly larger than the height of the first shell model 500′. The slightly increased height is configured to accommodate the thickness of the outer layer (e.g., the outer layer 40) and a thickness of the space between the inner and outer layers of the mouthpiece (including the mid-layer 42). As shown, the second shell model 700 includes a left portion 702, a right portion 704, and a front portion 706 connecting between the left portion 702 and the right portion 704. A concave side 708 of the second shell model 700 can define a cavity 720 extending between the left portion 702 and the right portion 704 and behind the front portion 706. A thickness of the second shell model 700 can be predefined.

As schematically depicted in FIG. 7B, an inner surface 710 of the second shell model 700 can be spaced apart from the front surface 530 of the first shell model 500′ so that a space is created therebetween. The space is sized to receive an embedded circuit board (e.g., the circuit board 20), a mid-layer (e.g., the mid-layer 42), and an outer layer (e.g., the outer layer 40) of the mouthpiece. For example, FIG. 7B shows that the space is partially occupied by the first object 610 representing the left arm of the circuit board, a part 712 of the space can accommodate the mid-layer of the mouthpiece, and another part 714 of the space can accommodate the outer layer of the mouthpiece. The dimension of the space can be determined based on parameters of the mouthpiece that specify dimensions (e.g., thicknesses) of the circuit board (and its components), the mid-layer, and the outer layer.

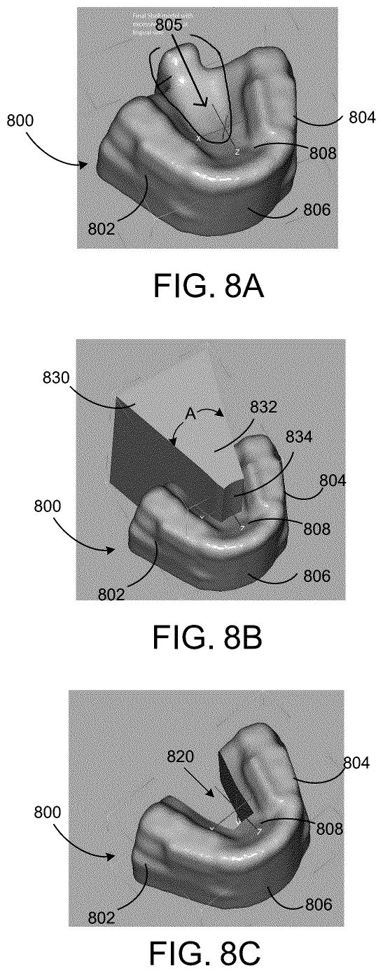

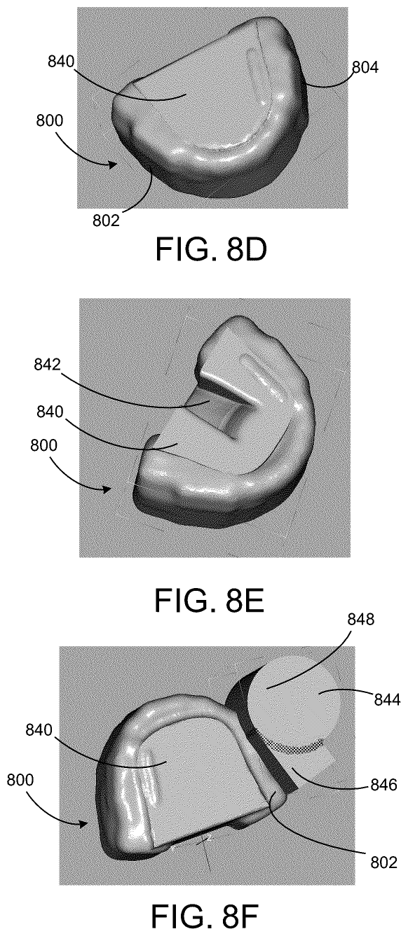

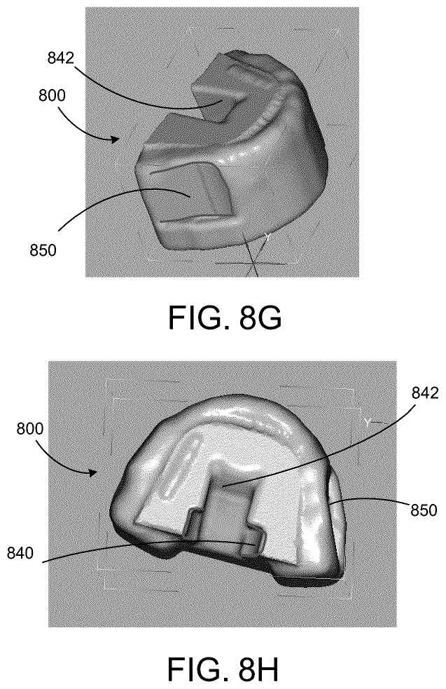

In some circumstances, the original teeth model (e.g., the teeth model 400) may include residuals of a palatal surface, which may be carried over when creating the first and second shell models. For example, FIG. 8A shows another second shell model 800 which includes an excessive portion 805 extending between a left wing 802 and a right wing 804, and behind a front portion 806 of the second shell model 800. As a result, no recess (like the cavity 720) extends behind the front portion 806. The excessive portion 805 can be an artifact representing the residual palatal surface existed in the received teeth model.

The excessive portion 805 can be automatically identified and removed (e.g., by the palate remover 238) from the second shell model 800 so that the palatal surface is prevented from appearing in the case insert model and the fabricated case insert. For example, the palate remover 238 can automatically generate a wedge 830 having a tapered head portion 832, as shown in FIG. 8B. The dimensions of the head portion 832 can be determined based on a geometry of the second shell model 800 so that the head portion 832 can be inserted into a concave side 808 of the second shell model 800. For example, the size and angle (A) of the head portion 832 can be configured such that when inserted into the concave side 808, the head portion 832 can maintain contact with the left wing 802, the right wing 804, and the front portion 806 of the second shell model 800. The head portion 832 can have a slightly curved end surface 834 configured to mate with a lingual surface of the front portion 806. Alternatively, the end surface 834 can be substantially flat. The wedge 830 can serve as a digital subtractor such than when the head portion 832 is removed, the excessive portion 805 can be substantially subtracted from the second shell model 800, leaving a cavity 820 extending between the left wing 802 and the right wing 804 and behind the front portion 806, as shown in FIG. 8C. In some examples, after removal of the excessive portion 805, surface smoothing can be applied to the concave side 808 of the second shell model 800 to remove sharp edges left therein, if any.

In some other examples, the lingual walls of the second shell model 800 are removed by applying a palatal filler surface 840 (e.g., by using the palate filler 239) into the recess between the left wing 802 and the right wing 804 of the second shell model. For example, as shown in FIG. 8D, the palate filler 239 can detect the maximum height of the occlusal surface of the second shell model 800 and fill the volume defined by the concave side 808 of the second shell model from a point that is a predetermined amount (e.g., 0.1 mm, 0.2 mm, 0.5 mm, 1 mm, etc.) below the maximum height. The result of the creation of the palatal filler surface 840 is a generally flat palatal surface and any remaining occlusal peaks defined by the underlying tooth model or the objects placed on the surface of the first shell model that extend above the maximum height. In some examples, an optional spacer 842 is added to the palatal surface 840, as shown in FIG. 8E. The size and shape of the spacer 842 are configured so as to accommodate a user's finger to facilitate easily lifting the mouthpiece from the case insert in which it is retained.

In some examples, an outer wall of either the left wing 802 or the right wing 804 is deformed in a manner to apply a force to the mouthpiece biasing the mouthpiece to a location in which a charging function of the mouthpiece case can be improved or optimized. As shown in FIG. 8F, the outer wall of the left wing 802 can be automatically deformed (e.g., by the wall deformer 241) on the second shell model 800 using a deformation object 844. The deformation object 844 includes a flat wall portion 846 and a rounded wall portion 848. The flat wall portion 846 is configured to engage the posterior end of the outer wall of the left wing 802, and the rounded wall portion 848 is configured to engage a portion of the outer wall of the left wing 802 that is anterior of the posterior end. More specifically, in some examples, a line that divides the posterior end of the outer wall of the left wing 802 from the anterior portion of the outer wall of the left wing 802 can be defined by a midpoint of the second object 620 that had been previously located on the first shell model, described above. The deformation object 844 is then placed adjacent to the outer wall of the left wing 802 and is pushed into the wall by a predetermined distance such as, for example, about 1-10 mm, or from 2-8 mm, or from 3-5 mm. The orientation of the deformation object 844 is such that it is parallel to the occlusal axis. The result of pushing the deformation object 844 into the outer wall of the left wing 802 is to create a wall bump or deformation 850, as shown by the marked region in FIG. 8G and in FIG. 8H.

In some examples, an electronic component space 852 is created on the second shell model 800 by subtracting a geometry that accommodates the electronics board sizes placed in the finished case insert 1000. The electronic component space 852 is shown by the markings in FIG. 8H. In the example shown, the electronic component space 852 is located on opposed sides of the spacer 842 near a posterior end of the second shell model 800.

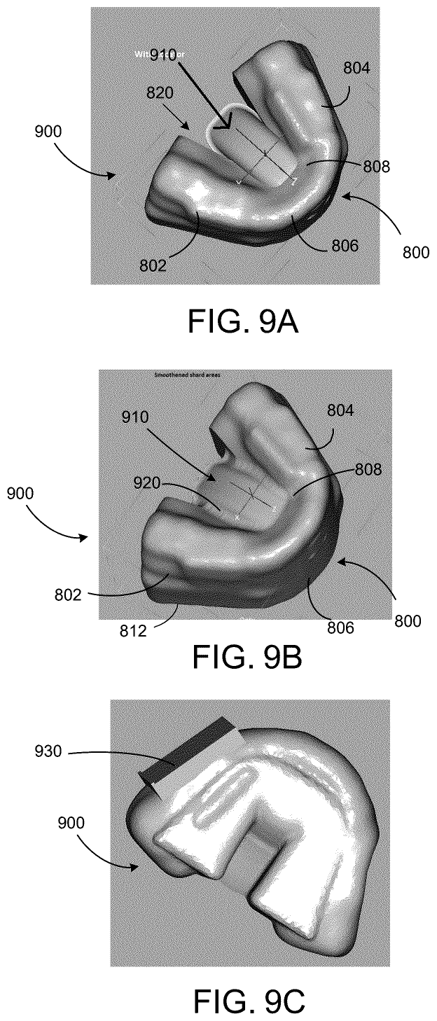

FIG. 9A shows a case insert model 900 which is created by adding a spacer 910 (e.g., by the inserter 236) to the second shell model 800 of FIG. 8C. The second shell model 800 depicted in FIG. 9A can also be replaced with other second shell models, such as the second shell model 700 of FIG. 7A. The spacer 910 models a corresponding spacer (also referred to as a “locator” or a “handle”) on the fabricated case insert, which can be sized to accommodate a user's finger to facilitate easily lifting the mouthpiece from the case insert in which it is retained.

As shown in FIG. 9A, the spacer 910 can extend in the cavity 820 formed between the left wing 802 and the right wing 804 and connected to the front portion 806 of the second shell model 800. In some examples, the spacer 910 can be connected to the left wing 802 and the right wing 804, and interfaces 920 between the spacer 910 and the second shell model 800 can be smoothed, as shown in FIG. 9B.

In some examples, the case insert model 900 can further include a base plate (not shown) added to the second shell model 800. The base plate can be connected to and extend from a bottom edge 812 of the second shell model 800. The base plate added to the case insert model 900 models a corresponding base plate on the fabricated case insert, as described below.

In some examples, as shown in FIG. 9C, the case insert model 900 can further include a flat mounting surface 930 that is located on an external surface of the case insert model 900 at a location that corresponds to the location of the underlying first component 610 on the first shell model 500′. The flat mounting surface 930 provides a surface upon which a charging coil (not shown) can be seated and attached to the case insert 1000. By selecting the location and size of the flat mounting surface 930, the location of the charging coil relative to a charging coil contained on the mouthpiece can be closely controlled. For example, in some circumstances the thickness of the flat mounting surface 930 is provided such that a minimum gap (e.g., between 0.5-5 mm, or between 1-4 mm, or between 2-3 mm) is provided between the external surface and internal surface of the case insert at the location of the flat mounting surface 930.

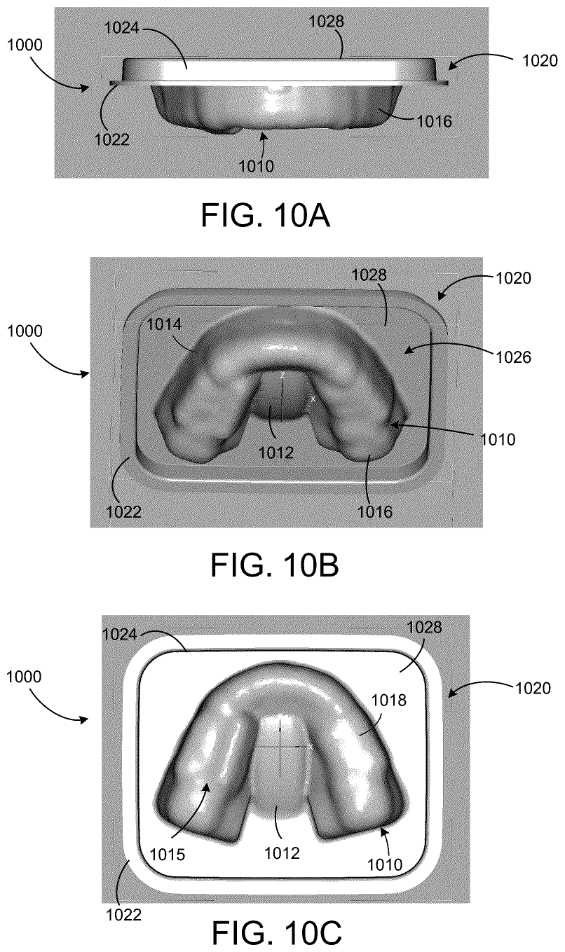

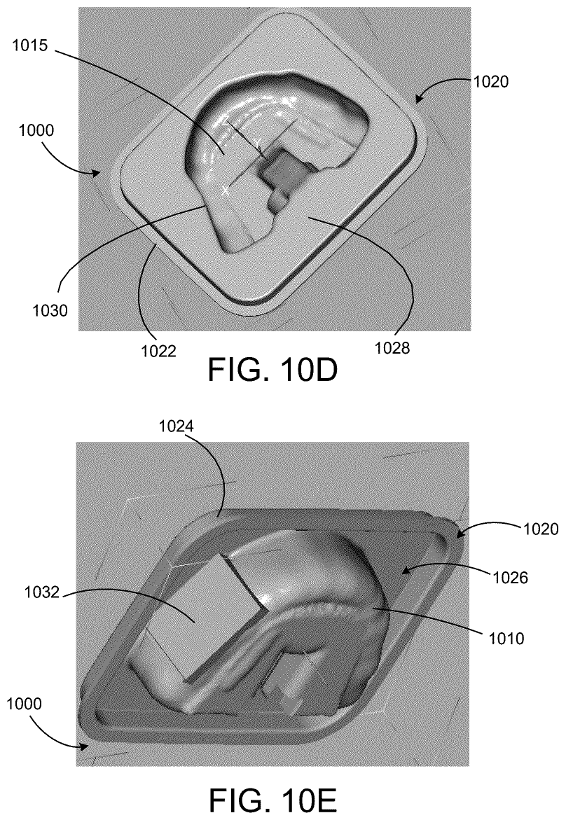

FIGS. 10A-10C depict a case insert 1000 for the mouthpiece. FIGS. 10D-E depict another example of a case insert 1000 for the mouthpiece that also includes a wall bump or deformation 1030 and a flat mounting surface 1032. The case insert 1000 is a physical 3D artifact fabricated (e.g., by the digital fabricator 250) based on the case insert model 900 of FIG. 9B. The case insert 1000 can include a shell 1010, a spacer 1012, and a base plate 1020 connected to the shell 1010. The shell 1010 and spacer 1012 can be respectively fabricated based on the second shell model 800 and the spacer 910 of FIG. 9B. The base plate 1020 can be fabricated based on the corresponding base plate added to the case insert model 900, as described above. In the depicted examples, the base plate 1020 has a generally rectangular shape. In other examples, the base plate 1020 can have different shapes (e.g., circular, oval, etc.).

In the depicted examples, the base plate 1020 includes a planar surface 1028, a side wall 1024 standing vertically on the planar surface 1028, and a rim 1022 extending outwardly from the side wall 1024 (and parallel to the planar surface 1028). The side wall 1024 can enclose a cavity 1026. A bottom edge of the shell 1010 (corresponding to the bottom edge 812 of the second shell model 800) and the spacer 1012 can be connected to the planar surface 1028. A bottom portion 1014 of the shell 1010 can be inside the cavity 1026 and a top portion 1016 of the shell 1010 can extend out of the base plate 1020.

The shell 1010 can enclose a recess 1015 with an opening on the planar surface 1028. Through the opening, a corresponding mouthpiece can be inserted into the recess 1015. Because the mouthpiece and the shell 1010 of the case insert 1000 can be fabricated based on the same or substantially the same teeth model, the shell 1010 is thus customized for the mouthpiece. Specifically, an inner surface 1018 of the shell 1010 has a contour which generally matches the contour or outer surface of the mouthpiece except for removal of areas representing teeth undercuts. Thus, the mouthpiece can be inserted through the opening and matingly received within the recess 1015 without hinderance. To remove the mouthpiece from the case insert 1000, a user can access the mouthpiece using the space provided by the spacer 1012 and lift the mouthpiece from the case insert.

In some examples, the case insert 1000 can be further enclosed within a case or container for the mouthpiece. Additional components, e.g., one or more transmitting coils can be added to the case or container so as to enable wireless charging of the mouthpiece received within the case insert 1000.

### Example Advantages

Compared to existing solutions, the technologies described herein for creating a case insert for a customized mouthpiece offers several advantages.

First, it addresses the issue of individualized case designs by accommodating the uniqueness of each mouthpiece, which is tailored to a specific user. By fabricating the case insert using the same or substantially the same teeth model that is used for making the mouthpiece, the proposed solution eliminates the need for creating the case insert after the mouthpiece (that is, the case insert could be manufactured concurrently with the mouthpiece to ensure availability when the mouthpiece is ready), thereby streamlining the manufacturing process and reducing waiting periods for the end user.

Second, the proposed method ensures a precise fit between the mouthpiece and the case insert. This precision is crucial when the case insert is designed to charge the mouthpiece's power supply unit or battery. By preventing any mismatch, the proposed method can ensure proper alignment between the transmitting and receiving coils, thereby enhancing the charging efficiency.

Further, the proposed method removes undercuts of the teeth model when producing the case insert, thereby allowing the mouthpiece to be easily inserted into the case insert without hinderance. Moreover, a spacer is further added to the case insert, thereby allowing a user to easily remove the mouthpiece from the case insert.

### Example Computing Systems

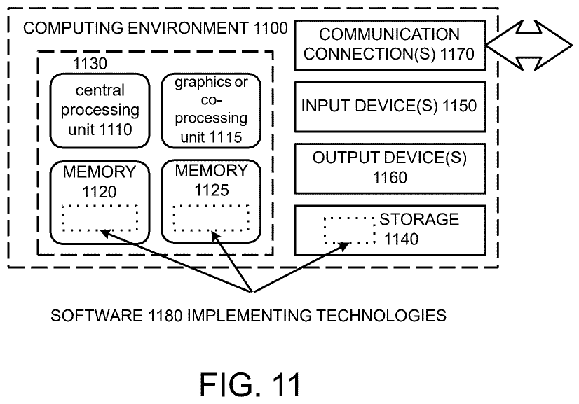

FIG. 11 depicts an example of a suitable computing system 1100 in which the described innovations can be implemented. For example, the computing system 1100 can be used in the modeling engine 220 and/or the digital fabricator 250 depicted in FIG. 2. The computing system 1100 is not intended to suggest any limitation as to scope of use or functionality of the present disclosure, as the innovations can be implemented in diverse computing systems.

With reference to FIG. 11, the computing system 1100 includes one or more processing units 1110, 1115 and memory 1120, 1125. In FIG. 11, this basic configuration 1130 is included within a dashed line. The processing units 1110, 1115 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 11 shows a central processing unit 1110 as well as a graphics processing unit or co-processing unit 1115. The tangible memory 1120, 1125 can be volatile memory (e.g., registers, cache, RAM), non-volatile memory (e.g., ROM, EEPROM, flash memory, etc.), or some combination of the two, accessible by the processing unit(s) 1110, 1115. The memory 1120, 1125 stores software 1180 implementing one or more innovations described herein, in the form of computer-executable instructions suitable for execution by the processing unit(s) 1110, 1115.

A computing system 1100 can have additional features. For example, the computing system 1100 includes storage 1140, one or more input devices 1150, one or more output devices 1160, and one or more communication connections 1170, including input devices, output devices, and communication connections for interacting with a user. An interconnection mechanism (not shown) such as a bus, controller, or network interconnects the components of the computing system 1100. Typically, operating system software (not shown) provides an operating environment for other software executing in the computing system 1100, and coordinates activities of the components of the computing system 1100.

The tangible storage 1140 can be removable or non-removable, and includes magnetic disks, magnetic tapes or cassettes, CD-ROMs, DVDs, or any other medium which can be used to store information in a non-transitory way and which can be accessed within the computing system 1100. The storage 1140 stores instructions for the software implementing one or more innovations described herein.

The input device(s) 1150 can be an input device such as a keyboard, mouse, pen, or trackball, a voice input device, a scanning device, touch device (e.g., touchpad, display, or the like) or another device that provides input to the computing system 1100. The output device(s) 1160 can be a display, printer, speaker, CD-writer, or another device that provides output from the computing system 1100.

The communication connection(s) 1170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various examples. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example Computer-Readable Media

Any of the computer-readable media herein can be non-transitory (e.g., volatile memory such as DRAM or SRAM, nonvolatile memory such as magnetic storage, can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### General Considerations

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved. The technologies from any example can be combined with the technologies described in any one or more of the other examples. In view of the many possible examples to which the principles of the disclosed technology may be applied, it should be recognized that the illustrated examples are only preferred examples and should not be taken as limiting the scope of the disclosed technology.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art. Any theories of operation are to facilitate explanation, but the disclosed systems, methods, and apparatus are not limited to such theories of operation.

As used in this application and in the claims, the singular forms “a,” “an,” and “the” include the plural forms unless the context clearly dictates otherwise. Additionally, the term “includes” means “comprises.” Further, the terms “coupled” and “connected” generally mean electrically, electromagnetically, and/or physically (e.g., mechanically or chemically) coupled or linked and does not exclude the presence of intermediate elements between the coupled or associated items absent specific contrary language.

Directions and other relative references (e.g., inner, outer, upper, lower, etc.) may be used to facilitate discussion of the drawings and principles herein, but are not intended to be limiting. For example, certain terms may be used such as “inside,” “outside,” “interior,” “exterior,” and the like. Such terms are used, where applicable, to provide some clarity of description when dealing with relative relationships, particularly with respect to the illustrated examples. Such terms are not, however, intended to imply absolute relationships, positions, and/or orientations. For example, with respect to an object, an “upper” part can become a “lower” part simply by turning the object over. Nevertheless, it is still the same part and the object remains the same.

As used herein, “and/or” means “and” or “or,” as well as “and” and “or.”

### Example Clauses

Any of the following example clauses can be implemented.

Clause 1. A method for making a case insert for a mouthpiece having an embedded circuit board, the method comprising: receiving a digital representation of a teeth model; creating a first shell model based at least in part on the digital representation of the teeth model; placing one or more objects modeling the embedded circuit board on the first shell model; creating a second shell model covering the first shell model and the one or more objects; and creating a case insert model based at least in part on the second shell model.

Clause 2. The method of clause 1, wherein creating the first shell model comprises filling one or more gaps between adjacent teeth in the digital representation of the teeth model.

Clause 3. The method of any one of clauses 1-2, wherein creating the first shell model comprises removing one or more tooth undercuts in the digital representation of the teeth model.

Clause 4. The method of clause 3, wherein removing one or more undercuts comprises identifying an undercut of a given tooth in the digital representation of the teeth model and filling the undercut of the given tooth.

Clause 5. The method of any one of clauses 1-4, wherein placing one or more objects modeling the embedded circuit board on the first shell model comprises: identifying a midline of the first shell model; placing a first object representing a left arm of the embedded circuit board on a first location; placing a second object representing a right arm of the embedded circuit board on a second location; placing a third object representing a battery connected to the embedded circuit board on a third location; and placing a fourth object representing a central leg of the embedded circuit board on a fourth location, wherein the first and second locations are on a facial surface of the first shell model and positioned on opposite sides of the midline, wherein the third location is on a lingual surface of the first shell model, and wherein the fourth location is aligned with the midline.

Clause 6. The method of any one of clauses 1-5, wherein creating the case insert model comprises identifying a palatal surface in the digital representation of the teeth model and preventing the palatal surface from appearing in the case insert model.

Clause 7. The method of clause 6, wherein preventing the palatal surface from appearing in the case insert model comprises defining a wedge block based on a geometry of the second shell model and inserting the wedge block into a concave side of the second shell model, wherein inserting the wedge block is configured to subtract the palatal surface from the second shell model.

Clause 8. The method of any one of clauses 1-7, wherein creating the case insert model comprises adding a spacer to the second shell model, wherein the spacer extends in a cavity formed between a left wing and a right wing of the second shell model.

Clause 9. The method of any one of clauses 1-8, further comprising generating a three-dimensional artifact of the case insert model.

Clause 10. The method of any one of clauses 1-9, wherein the mouth piece comprises an inner layer, an outer layer, and a mid-layer positioned between the inner layer and the outer layer, wherein a substantial portion of the embedded circuit board is sandwiched between the inner layer and the mid-layer, wherein a thickness of the first shell model is defined by the inner layer of the mouthpiece, wherein a space between the first shell model and the second shell model is sized to receive the embedded circuit board, the mid-layer, and the outer layer of the mouthpiece.

Clause 11. A system for making a case insert for a mouthpiece having an embedded circuit board, the system comprising: memory; one or more hardware processors coupled to the memory; and one or more computer readable storage media storing instructions that, when loaded into the memory, cause the one or more hardware processors to perform operations comprising: receiving a digital representation of a teeth model; creating a first shell model based at least in part on the digital representation of the teeth model; placing one or more objects modeling the embedded circuit board on the first shell model; creating a second shell model covering the first shell model and the one or more objects; and creating a case insert model based at least in part on the second shell model.

Clause 12. The system of clause 11, wherein creating the first shell model comprises filling one or more gaps between adjacent teeth in the digital representation of the teeth model.

Clause 13. The system of any one of clauses 11-12, wherein creating the first shell model comprises removing one or more tooth undercuts in the digital representation of the teeth model.

Clause 14. The system of clause 13, wherein removing one or more undercuts comprises identifying an undercut of a given tooth in the digital representation of the teeth model and filling the undercut of the given tooth.

Clause 15. The system of any one of clauses 11-14, wherein placing one or more objects modeling the embedded circuit board on the first shell model comprises: identifying a midline of the first shell model; placing a first object representing a left arm of the embedded circuit board on a first location; placing a second object representing a right arm of the embedded circuit board on a second location; placing a third object representing a battery connected to the embedded circuit board on a third location; and placing a fourth object representing a central leg of the embedded circuit board on a fourth location, wherein the first and second locations are on a facial surface of the first shell model and positioned on opposite sides of the midline, wherein the third location is on a lingual surface of the first shell model, and wherein the fourth location is aligned with the midline.

Clause 16. The system of any one of clauses 11-15, wherein creating the case insert model comprises identifying a palatal surface in the digital representation of the teeth model and preventing the palatal surface from appearing in the case insert model.

Clause 17. The system of clause 16, wherein preventing the palatal surface from appearing in the case insert model comprises defining a wedge block based on a geometry of the second shell model and inserting the wedge block into a concave side of the second shell model, wherein inserting the wedge block is configured to subtract the palatal surface from the second shell model.

Clause 18. The system of any one of clauses 11-17, wherein creating the case insert model comprises adding a spacer to the second shell model, wherein the spacer extends in a cavity formed between a left wing and a right wing of the second shell model.

Clause 19. The system of any one of clauses 11-18, further comprising a printer configured to print a three-dimensional artifact of the case insert model.

Clause 20. One or more non-transitory computer-readable media having encoded thereon computer-executable instructions causing one or more processors to perform a method, the method comprising: receiving a digital representation of a teeth model; creating a first shell model based at least in part on the digital representation of the teeth model; placing one or more objects modeling the embedded circuit board on the first shell model; creating a second shell model covering the first shell model and the one or more objects; and creating a case insert model based at least in part on the second shell model.

### Example Alternatives

The technologies from any example can be combined with the technologies described in any one or more of the other examples. In view of the many possible examples to which the principles of the disclosed technology can be applied, it should be recognized that the illustrated embodiments are examples of the disclosed technology and should not be taken as a limitation on the scope of the disclosed technology. Rather, the scope of the claimed subject matter is defined by the following claims and their equivalents.

What is claimed is:

1. A method for making a case insert for a mouthpiece having an embedded circuit board, the method comprising:
receiving a digital representation of a teeth model;
creating a first shell model based at least in part on the digital representation of the teeth model;
placing one or more objects modeling the embedded circuit board on the first shell model;
creating a second shell model covering the first shell model and the one or more objects; and
creating a case insert model based at least in part on the second shell model.

2. The method of claim 1, wherein creating the first shell model comprises filling one or more gaps between adjacent teeth in the digital representation of the teeth model.

3. The method of claim 1, wherein creating the first shell model comprises removing one or more tooth undercuts in the digital representation of the teeth model.

4. The method of claim 3, wherein removing one or more undercuts comprises identifying an undercut of a given tooth in the digital representation of the teeth model and filling the undercut of the given tooth.

5. The method of claim 1, wherein placing one or more objects modeling the embedded circuit board on the first shell model comprises:
identifying a midline of the first shell model;
placing a first object representing a left arm of the embedded circuit board on a first location;
placing a second object representing a right arm of the embedded circuit board on a second location;
placing a third object representing a battery connected to the embedded circuit board on a third location; and
placing a fourth object representing a central leg of the embedded circuit board on a fourth location,
wherein the first and second locations are on a facial surface of the first shell model and positioned on opposite sides of the midline,
wherein the third location is on a lingual surface of the first shell model, and
wherein the fourth location is aligned with the midline.

6. The method of claim 1, wherein creating the case insert model comprises identifying a palatal surface in the digital representation of the teeth model and preventing the palatal surface from appearing in the case insert model.

7. The method of claim 6, wherein preventing the palatal surface from appearing in the case insert model comprises defining a wedge block based on a geometry of the second shell model and inserting the wedge block into a concave side of the second shell model, wherein inserting the wedge block is configured to subtract the palatal surface from the second shell model.

8. The method of claim 1, wherein creating the case insert model comprises adding a spacer to the second shell model, wherein the spacer extends in a cavity formed between a left wing and a right wing of the second shell model.

9. The method of claim 1, further comprising generating a three-dimensional artifact of the case insert model.

10. The method of claim 1, wherein the mouthpiece comprises an inner layer, an outer layer, and a mid-layer positioned between the inner layer and the outer layer, wherein a substantial portion of the embedded circuit board is sandwiched between the inner layer and the mid-layer, wherein a thickness of the first shell model is defined by the inner layer of the mouthpiece, wherein a space between the first shell model and the second shell model is sized to receive the embedded circuit board, the mid-layer, and the outer layer of the mouthpiece.

11. A system for making a case insert for a mouthpiece having an embedded circuit board, the system comprising:
memory;
one or more hardware processors coupled to the memory; and
one or more computer readable storage media storing instructions that, when loaded into the memory, cause the one or more hardware processors to perform operations comprising:
receiving a digital representation of a teeth model;
creating a first shell model based at least in part on the digital representation of the teeth model;
placing one or more objects modeling the embedded circuit board on the first shell model;
creating a second shell model covering the first shell model and the one or more objects; and
creating a case insert model based at least in part on the second shell model.

12. The system of claim 11, wherein creating the first shell model comprises filling one or more gaps between adjacent teeth in the digital representation of the teeth model.

13. The system of claim 11, wherein creating the first shell model comprises removing one or more tooth undercuts in the digital representation of the teeth model.

14. The system of claim 13, wherein removing one or more undercuts comprises identifying an undercut of a given tooth in the digital representation of the teeth model and filling the undercut of the given tooth.

15. The system of claim 11, wherein placing one or more objects modeling the embedded circuit board on the first shell model comprises:
identifying a midline of the first shell model;
placing a first object representing a left arm of the embedded circuit board on a first location;
placing a second object representing a right arm of the embedded circuit board on a second location;
placing a third object representing a battery connected to the embedded circuit board on a third location; and
placing a fourth object representing a central leg of the embedded circuit board on a fourth location,
wherein the first and second locations are on a facial surface of the first shell model and positioned on opposite sides of the midline,
wherein the third location is on a lingual surface of the first shell model, and
wherein the fourth location is aligned with the midline.

16. The system of claim 11, wherein creating the case insert model comprises identifying a palatal surface in the digital representation of the teeth model and preventing the palatal surface from appearing in the case insert model.

17. The system of claim 16, wherein preventing the palatal surface from appearing in the case insert model comprises defining a wedge block based on a geometry of the second shell model and inserting the wedge block into a concave side of the second shell model, wherein inserting the wedge block is configured to subtract the palatal surface from the second shell model.

18. The system of claim 11, wherein creating the case insert model comprises adding a spacer to the second shell model, wherein the spacer extends in a cavity formed between a left wing and a right wing of the second shell model.

19. The system of claim 11, further comprising a printer configured to print a three-dimensional artifact of the case insert model.

20. One or more non-transitory computer-readable media having encoded thereon computer-executable instructions causing one or more processors to perform a method for making a case insert for a mouthpiece having an embedded circuit board, the method comprising:
receiving a digital representation of a teeth model;
creating a first shell model based at least in part on the digital representation of the teeth model;
placing one or more objects modeling the embedded circuit board on the first shell model;
creating a second shell model covering the first shell model and the one or more objects; and
creating a case insert model based at least in part on the second shell model.
